(19) United States
(12) Patent Application Publication
(10) Pub. No.: US 2025/0184187 A1
(43) Pub. Date: Jun. 5, 2025

(54) METHODS, APPARATUS, AND ARTICLES OF MANUFACTURE TO COMMUNICATE MULTIPLE SIGNALS OVER AN ISOLATION CHANNEL

(71) Applicant: Texas Instruments Incorporated, Dallas, TX (US)

(72) Inventors: Sooping Saw, McKinney, TX (US); Giacomo Calabrese, Freising (DE); Craig Bennett Greenberg, Mount Vernon, TX (US)

(21) Appl. No.: 18/790,544

(22) Filed: Jul. 31, 2024

Related U.S. Application Data
(60) Provisional application No. 63/605,737, filed on Dec. 4, 2023.

(51) Int. Cl. H04L 25/02; H01F 19/08

(52) U.S. Cl. CPC H04L 25/0266; H01F 19/08; H04L 25/026; H01F 2019/085

(57) ABSTRACT

An example apparatus includes a first die having a first terminal. The apparatus includes a second die having a second terminal. The apparatus includes an isolation channel coupled between the first terminal of the first die and the second terminal of the second die. The apparatus includes control circuitry disposed on the first die, the control circuitry to cause transmission of a power signal over the isolation channel and at least one of cause transmission of a control data signal over the isolation channel or detect a feedback data signal over the isolation channel. Other examples are described.

### CROSS-REFERENCE TO RELATED APPLICATION

This patent application claims the benefit of and priority to U.S. Provisional Patent Application No. 63/605,737 filed Dec. 4, 2023, which application is hereby incorporated herein by reference in its entirety.

### TECHNICAL FIELD

This description relates generally to communication systems and, more particularly, to methods, apparatus, and articles of manufacture to communicate multiple signals over an isolation channel.

### BACKGROUND

Isolation communication includes data transfer over an isolation barrier. Isolation communication systems provide isolation between circuits operating at dissimilar voltages on opposite sides of the isolation barrier. An isolation communication system can include a number of passive or active components on either side of the isolation barrier. In some examples, the isolation barrier includes an isolation channel such as a magnetic channel (e.g., inductively coupled coils, one or more coreless transformers, etc.) or a capacitive channel.

### SUMMARY

For methods, apparatus, and articles of manufacture to communication multiple signals over an isolation channel, an example apparatus includes a first die having a first terminal. The apparatus includes a second die having a second terminal. The apparatus includes an isolation channel coupled between the first terminal of the first die and the second terminal of the second die. The apparatus includes control circuitry disposed on the first die, the control circuitry to cause transmission of a power signal over the isolation channel and at least one of cause transmission of a control data signal over the isolation channel or detect a feedback data signal over the isolation channel. Other examples are described.

For methods, apparatus, and articles of manufacture to communication multiple signals over an isolation channel, an example system includes a processor integrated circuit (IC) having an output terminal and an input terminal. The system includes a gate driver IC having an isolation channel, a first output terminal on a first side of the isolation channel, a second output terminal on a second side of the isolation channel, and an input terminal on the first side of the isolation channel, the first output terminal of the gate driver IC coupled to the input terminal of the processor IC, the input terminal of the gate driver IC coupled to the output terminal of the processor IC. The system includes a power switch having a control terminal coupled to the second output terminal of the gate driver IC, the gate driver IC to: at least one of (a) cause transmission of a control data signal for the power switch over the isolation channel or (b) provide a feedback data signal received from the second side of the isolation channel to the processor IC, the feedback data signal indicative of a status associated with the power switch; and cause transmission of a power signal for driving the power switch over the isolation channel. Other examples are described.

For methods, apparatus, and articles of manufacture to communication multiple signals over an isolation channel, an example apparatus includes a first die having a first terminal. The apparatus includes a second die having a second terminal. The apparatus includes an isolation channel coupled between the first terminal of the first die and the second terminal of the second die. The apparatus includes control circuitry disposed on the first die, the control circuitry to: cause transmission of a control data signal over the isolation channel during a first portion of a communication period; detect a feedback data signal during a second portion of the communication period; and cause transmission of a power signal over the isolation channel during a third portion of the communication period. Other examples are described.

### BRIEF DESCRIPTION OF THE DRAWINGS

FIG. 1 is a block diagram of an example system including an example gate driver circuit.

FIG. 2A and FIG. 2B are a block diagram of an example implementation of the gate driver circuit of FIG. 1.

FIG. 3 illustrates an example transmission of forward (FWD) data, backward (BWD) data, and power in a time-multiplexed manner over an isolation channel of the gate driver circuit of FIGS. 2A and 2B.

FIG. 4 is a flowchart representative of at least one of example machine-readable instructions or example operations that may be at least one of executed, instantiated, or performed using an example programmable circuitry implementation of the first die of the gate driver circuit of FIGS. 2A and 2B.

FIG. 5 is a flowchart representative of at least one of example machine-readable instructions or example operations that may be at least one of executed, instantiated, or performed using an example programmable circuitry implementation of the second die of the gate driver circuit of FIGS. 2A and 2B.

FIG. 6 is a block diagram of an example processing platform including programmable circuitry structured to at least one of execute, instantiate, or perform at least one of the example machine-readable instructions or the example operations of FIGS. 4 and 5 to implement the gate driver circuit of FIGS. 2A and 2B.

The drawings are not necessarily to scale. Generally, the same reference numbers in the drawing(s) and this description refer to the same or similar (in terms of at least one of functional or structural) at least one of features or parts. Although the drawings show regions with clean lines and boundaries, some or all of these lines and boundaries may be idealized. In reality, the boundaries or lines may be unobservable, blended, or irregular.

### DETAILED DESCRIPTION

In automotive vehicles, a relay is used to control at least one of a high-amperage circuit or a high-voltage circuit using at least one of a low-amperage circuit or a low-voltage circuit. For example, an electromechanical relay includes electrical contacts that can be coupled to at least one of a high-amperage circuit or a high-voltage circuit, an armature, and a coil that can be energized by at least one of a low-amperage circuit or a low-voltage circuit to control the armature to at least one of open or close the electrical contacts and at least one of complete or break at least one of the high-amperage circuit or the high-voltage circuit.

In other examples, a relay can be used to control at least one of a low-amperage or low-voltage circuit using at least one of another low-amperage circuit or another low-voltage circuit. In additional examples, a relay can be used to control at least one of a high-amperage or high-voltage circuit using at least one of another high-amperage circuit or another high-voltage circuit.

In some instances, electromechanical relays have been replaced by solid-state relays that include transistors. For example, manufacturers of automotive electric vehicles (EVs) and hybrid electric vehicles (HEVs) have replaced electromechanical relays with solid-state relays. In examples described herein, a solid-state relay includes at least one gate driver circuit and at least one transistor (e.g., at least one power field-effect transistor (FET)). To comply with safety standards in automotive applications, solid-state relays include an isolated gate driver circuit. For example, an isolated gate driver circuit includes an isolation barrier that implements Galvanic isolation to isolate at least one of a low-amperage circuit or a low-voltage circuit from at least one of a high-amperage circuit or a high-voltage circuit. Thus, the isolation barrier electrically separates a low amperage or low voltage domain from a high amperage or high voltage domain. Thus, by implementing an isolation barrier, an isolated gate driver circuit prevents current from flowing between (1) at least one of a low-amperage circuit or a low-voltage circuit and (2) at least one of a high-amperage circuit or a high-voltage circuit.

Isolation barriers can be implemented at the board level or in an integrated circuit. To maintain isolation, isolated gate driver circuits include a dedicated floating power supply. Some isolated gate driver circuits include an integrated floating power supply which reduces the footprint and monetary cost to implement an isolated gate driver circuit.

Also, to maintain isolation, isolated gate driver circuits include isolation channels to communicate signals across an isolation barrier. Such isolation channels are unidirectional. For example, a unidirectional isolation channel from a low-voltage circuit to a high-voltage circuit permits the low-voltage circuit to only transmit a signal to or only receive a signal from the high-voltage circuit, but not both. Example isolation channels include at least one of a transformer, an optical isolator, a capacitor, a Hall-effect sensor, or a magnetocoupler. As such, isolated gate driver circuits include a separate isolation channel for each signal transferred over an isolation barrier.

Thus, an isolated gate driver circuit will include three isolation channels to transfer three signals over an isolation barrier. For example, the isolated gate driver circuit includes a first dedicated isolation channel to transfer a power signal from a low-voltage circuit to a high-voltage circuit over the isolation barrier. Also, the isolated gate driver circuit includes a second dedicated isolation channel to communicate a first data signal from the low-voltage circuit to the high-voltage circuit over the isolation barrier. Furthermore, the isolated gate driver circuit includes a third dedicated isolation channel to communicate a secondary data signal from the high-voltage circuit to the low-voltage circuit over the isolation barrier. As such, the isolated gate driver circuit includes three isolation channels to transfer three signals over the isolation barrier. More broadly, an isolated gate driver circuit that transfers N signals over an isolation barrier includes N isolation channels.

Owing to the fact that each signal requires a separate channel, transferring more signals over an isolation barrier increases the footprint and monetary cost to implement an isolated gate driver circuit. For example, each additional isolation channel adds 15-20% to the total monetary cost of an isolated gate driver circuit. Also, increasing the number of isolation channels across an isolation barrier increases the difficulty of implementing an isolated gate driver as an integrated circuit. Some isolation channel types (e.g., transformers, Hall-effect sensors, magnetocouplers, etc.) are physically large. For example, a single isolation channel can take up as much as 20% of the footprint of an integrated isolated gate driver circuit. As such, integrating multiple isolation channels into a single package is difficult.

Examples described herein include an isolated gate driver circuit capable of transferring multiple signals over a single bidirectional isolation channel (e.g., a bidirectional communication channel). For example, a bidirectional isolation channel from a low-voltage circuit to a high-voltage circuit permits the low-voltage circuit to both transmit a signal to and receive a signal from the high-voltage circuit. As such, examples described herein include an isolated gate driver circuit that transfers a power signal from a low-voltage circuit to a high-voltage circuit over an isolation channel, communicates a control data signal from the low-voltage circuit to the high-voltage circuit over the isolation channel, and communicates a feedback data signal from the high-voltage circuit to the low-voltage circuit over the isolation channel. For example, the feedback data signal includes fault diagnostic data. Accordingly, examples described herein include an industrial isolated gate driver circuit including integrated diagnostic feedback and having a footprint and monetary cost that is reduced with respect to other isolated gate driver circuits that transfer multiple signals across an isolation barrier. For example, example isolated gate driver circuits described herein are industrial in that the example isolated gate driver circuits are utilized in enterprise level applications (e.g., automotive applications, manufacturing applications, etc.).

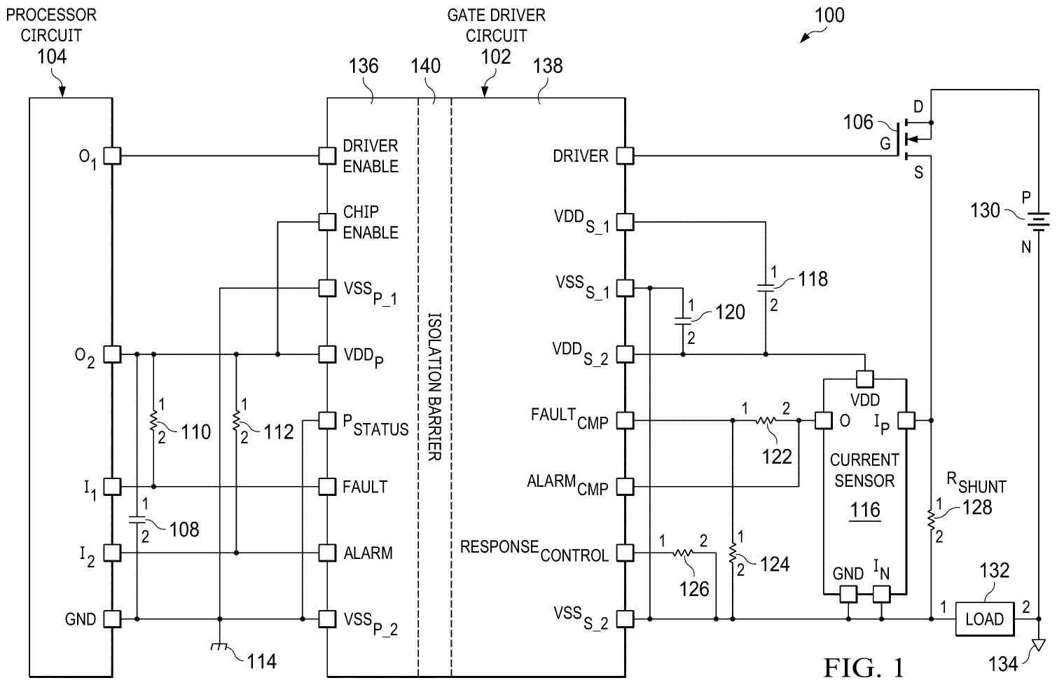

FIG. 1 is a block diagram of an example system 100 including an example gate driver circuit 102. The example system 100 also includes an example processor circuit 104, an examples switch 106, a first example capacitor 108, a first example resistor 110, a second example resistor 112, and an example chassis ground terminal 114. In the example of FIG. 1, the system 100 also includes an example current sensor 116, a second example capacitor 118, a third example capacitor 120, a third example resistor 122, a fourth example resistor 124, a fifth example resistor 126, a sixth example resistor 128, an example power source 130, an example load 132, and an example signal ground terminal 134. In the example of FIG. 1, the isolated gate driver circuit 102 includes a first example die 136, a second example die 138, and an example isolation barrier 140.

In the illustrated example of FIG. 1, the first die 136 operates as a primary side of the gate driver circuit 102 and the second die 138 operates as a secondary side of the gate driver circuit 102. In the example of FIG. 1, the first die 136 has a driver enable terminal (DRIVER ENABLE), a chip enable terminal (CHIP ENABLE), a first primary side ground terminal (VSS_{P_1}), a primary side supply terminal (VDD_{P}), a power status terminal (P_{STATUS}), a fault terminal (FAULT), an alarm terminal (ALARM), and a second primary side ground terminal (VSS_{P_2}). In the example of FIG. 1, the second die 138 has a driver terminal (DRIVER), a first secondary side supply terminal (VDD_{S_1}), a first secondary side ground terminal (VSS_{S_1}), a second secondary side supply terminal (VDD_{S_2}), a fault comparator terminal (FAULT_{CMP}), an alarm comparator terminal (ALARM_{CMP}), a response control terminal (RESPONSE_{CONTROL}), and a second secondary side ground terminal (VSS_{S_2}). In the example of FIG. 1, the processor circuit 104 has a first output terminal (O₁), a second output terminal (O₂), a first input terminal (I₁), a second input terminal (I₂), and a ground terminal (GND).

In the illustrated example of FIG. 1, the switch 106 has a gate terminal (G), a drain terminal (D), and a source terminal(S). In the example of FIG. 1, each of the first capacitor 108, the first resistor 110, the second resistor 112, the second capacitor 118, the third capacitor 120, the third resistor 122, the fourth resistor 124, the fifth resistor 126, the sixth resistor 128, and the load 132 has a first terminal and a second terminal. In the example of FIG. 1, the current sensor 116 has a supply terminal (VDD), a ground terminal (GND), a positive input terminal (I_{P}), a negative input terminal (I_{N}), and an output terminal (O). Also, in the example of FIG. 1, the power source 130 has a positive terminal (P) and a negative terminal (N).

In the illustrated example of FIG. 1, the gate driver circuit 102 is implemented as an integrated circuit (IC) including the first die 136 and the second die 138. As such, the gate driver circuit 102 may be referred to as a gate driver IC. In some examples, the first die 136 and the second die 138 are implemented in separate ICs. In the example of FIG. 1, the first die 136 of the gate driver circuit 102 is implemented by a semiconductor die (e.g., a silicon (Si) die). Also, the driver enable terminal of the gate driver circuit 102 is coupled to the first output terminal of the processor circuit 104. In the example of FIG. 1, the chip enable terminal of the gate driver circuit 102 is coupled to the primary side supply terminal of the gate driver circuit 102 and the second output terminal of the processor circuit 104. Also, the chip enable terminal of the gate driver circuit 102 is coupled to the first terminal of the first capacitor 108, the first terminal of the first resistor 110, and the first terminal of the second resistor 112.

In the illustrated example of FIG. 1, the first primary side ground terminal of the gate driver circuit 102 is coupled to the second primary side ground terminal and the power status terminal of the gate driver circuit 102. In the example of FIG. 1, the first primary side ground terminal of the gate driver circuit 102 is coupled to the ground terminal of the processor circuit 104 and the chassis ground terminal 114. Also, the first primary side ground terminal of the gate driver circuit 102 is coupled to the second terminal of the first capacitor 108.

In the illustrated example of FIG. 1, the primary side supply terminal of the gate driver circuit 102 is coupled to the chip enable terminal of the gate driver circuit 102 and the second output terminal of the processor circuit 104. Also, the primary side supply terminal of the gate driver circuit 102 is coupled to the first terminal of the first capacitor 108, the first terminal of the first resistor 110, and the first terminal of the second resistor 112. In the example of FIG. 1, the power status terminal of the gate driver circuit 102 is coupled to the first primary side ground terminal and the second primary side ground terminal of the gate driver circuit 102. In the example of FIG. 1, the power status terminal of the gate driver circuit 102 is coupled to the ground terminal of the processor circuit 104 and the chassis ground terminal 114. Also, the power status terminal of the gate driver circuit 102 is coupled to the second terminal of the first capacitor 108.

In the illustrated example of FIG. 1, the fault terminal of the gate driver circuit 102 is coupled to the first input terminal of the processor circuit 104 and the second terminal of the first resistor 110. Also, the alarm terminal of the gate driver circuit 102 is coupled to the second input terminal of the processor circuit 104 and the second terminal of the second resistor 112. In the example of FIG. 1, the second primary side ground terminal of the gate driver circuit 102 is coupled to the first primary side ground terminal and the power status terminal of the gate driver circuit 102. Also, the second primary side ground terminal of the gate driver circuit 102 is coupled to the ground terminal of the processor circuit 104 and the chassis ground terminal 114. In the example of FIG. 1, the second primary side ground terminal of the gate driver circuit 102 is coupled to the second terminal of the first capacitor 108.

In the illustrated example of FIG. 1, the second die 138 of the gate driver circuit 102 is implemented by a semiconductor die (e.g., an Si die). In the example of FIG. 1, the driver terminal of the gate driver circuit 102 is coupled to the gate terminal of the switch 106. Also, the first secondary side supply terminal of the gate driver circuit 102 is coupled to the first terminal of the second capacitor 118. In the example of FIG. 1, the first secondary side ground terminal of the gate driver circuit 102 is coupled to the first terminal of the third capacitor 120. Also, the first secondary side ground terminal of the gate driver circuit 102 is coupled to the second secondary side ground terminal of the gate driver circuit 102, the ground terminal of the current sensor 116, the negative input terminal of the current sensor 116, the second terminal of the fourth resistor 124, the second terminal of the fifth resistor 126, the second terminal of the sixth resistor 128, and the first terminal of the load 132.

In the illustrated example of FIG. 1, the second secondary side supply terminal of the gate driver circuit 102 is coupled to the supply terminal of the current sensor 116, the second terminal of the second capacitor 118, and the second terminal of the third capacitor 120. In the example of FIG. 1, the fault comparator terminal of the gate driver circuit 102 is coupled to the first terminal of the third resistor 122 and the first terminal of the fourth resistor 124. Also, the alarm comparator terminal of the gate driver circuit 102 is coupled to output terminal of the current sensor 116 and the second terminal of the third resistor 122.

In the illustrated example of FIG. 1, the response control terminal of the gate driver circuit 102 is coupled to the first terminal of the fifth resistor 126. In the example of FIG. 1, the second secondary side ground terminal of the gate driver circuit 102 is coupled to the first secondary side ground terminal of the gate driver circuit 102, the ground terminal of the current sensor 116, and the negative input terminal of the current sensor 116. Also, the second secondary side ground terminal of the gate driver circuit 102 is coupled to the first terminal of the third capacitor 120, the second terminal of the fourth resistor 124, the second terminal of the fifth resistor 126, the second terminal of the sixth resistor 128, and the first terminal of the load 132.

In the illustrated example of FIG. 1, the processor circuit 104 is implemented by a microcontroller. In some examples, the processor circuit 104 is implemented as an IC. As such, the processor circuit 104 may be referred to as a processor IC or a processor integrated circuit. In the example of FIG. 1, the first output terminal of the processor circuit 104 is coupled to the driver enable terminal of the gate driver circuit 102. Also, the second output terminal of the processor circuit 104 is coupled to the chip enable terminal and the primary side supply terminal of the gate driver circuit 102. In the example of FIG. 1, the second output terminal of the processor circuit 104 is coupled the first terminal of the first capacitor 108, the first terminal of the first resistor 110, and the first terminal of the second resistor 112.

In the illustrated example of FIG. 1, the first input terminal of the processor circuit 104 is coupled to the fault terminal of the gate driver circuit 102. In the example of FIG. 1, the first input terminal of the processor circuit 104 is coupled to the second terminal of the first resistor 110. Also, the second input terminal of the processor circuit 104 is coupled to the alarm terminal of the gate driver circuit 102. In the example of FIG. 1, the second input terminal of the processor circuit 104 is coupled to the second terminal of the second resistor 112. Also, the ground terminal of the processor circuit 104 is coupled to the chassis ground terminal 114 and the second terminal of the first capacitor 108. In the example of FIG. 1, the ground terminal of the processor circuit 104 is coupled to the first primary side ground terminal, the second primary side ground terminal, and the power status terminal of the gate driver circuit 102.

In the illustrated example of FIG. 1, the switch 106 is implemented by an n-channel metal-oxide semiconductor field-effect transistor (MOSFET). Alternatively, the switch 106 may be implemented by an n-channel field-effect transistor (FET), an n-channel insulated-gate bipolar transistor (IGBT), an n-channel junction field effect transistor (JFET), a negative-positive-negative (NPN) bipolar junction transistor (BJT) or, with slight modifications, a p-type equivalent device. In the example of FIG. 1, the switch 106 may be a depletion mode device, a drain-extended device, an enhancement mode device, a natural transistor, or other type of device structure transistor. Furthermore, the switch 106 may be implemented at least one of in or over an Si substrate, a silicon carbide (SiC) substrate, a gallium nitride (GaN) substrate, or a gallium arsenide (GaAs) substrate.

In the illustrated example of FIG. 1, the gate terminal of the switch 106 is coupled to the driver terminal of the gate driver circuit 102. In the example of FIG. 1, the drain terminal of the switch 106 is coupled to the positive terminal of the power source 130. Also, the source terminal of the switch 106 is coupled to the first terminal of the sixth resistor 128. In the example of FIG. 1, the source terminal of the switch 106 is also coupled to the positive input terminal of the current sensor 116 and the first terminal of the sixth resistor 128.

In the illustrated example of FIG. 1, the first terminal of the first capacitor 108 is coupled to the chip enable terminal and the primary side supply terminal of the gate driver circuit 102. In the example of FIG. 1, the first terminal of the first capacitor 108 is coupled to the second output terminal of the processor circuit 104. Also, the first terminal of the first capacitor 108 is coupled to the first terminal of the first resistor 110 and the first terminal of the second resistor 112. In the example of FIG. 1, the second terminal of the first capacitor 108 is coupled to the first primary side ground terminal, the second primary side ground terminal, and the power status terminal of the gate driver circuit 102. Also, the second terminal of the first capacitor 108 is coupled to the ground terminal of the processor circuit 104 and the chassis ground terminal 114.

In the illustrated example of FIG. 1, the first terminal of the first resistor 110 is coupled to the chip enable terminal and the primary side supply terminal of the gate driver circuit 102. In the example of FIG. 1, the first terminal of the first resistor 110 is coupled to the second output terminal of the processor circuit 104. Also, the first terminal of the first resistor 110 is coupled to the first terminal of the first capacitor 108 and the first terminal of the second resistor 112. In the example of FIG. 1, the second terminal of the first resistor 110 is coupled to the fault terminal of the gate driver circuit 102 and the first input terminal of the processor circuit 104.

In the illustrated example of FIG. 1, the first terminal of the second resistor 112 is coupled to the chip enable terminal and the primary side supply terminal of the gate driver circuit 102. In the example of FIG. 1, the first terminal of the second resistor 112 is coupled to the second output terminal of the processor circuit 104. Also, the first terminal of the second resistor 112 is coupled to the first terminal of the first capacitor 108 and the first terminal of the first resistor 110. In the example of FIG. 1, the second terminal of the second resistor 112 is coupled to the alarm terminal of the gate driver circuit 102 and the second input terminal of the processor circuit 104.

In the illustrated example of FIG. 1, the chassis ground terminal 114 is a common terminal to which electrical components on the primary side of the isolation barrier 140 are coupled. In the example of FIG. 1, the chassis ground terminal 114 may or may not be coupled to the Earth. For example, if the system 100 is implemented in an automotive application (e.g., an EV or an HEV application), the chassis ground terminal 114 may be the chassis of a vehicle where the chassis is not coupled to the Earth. Also or alternatively, if the system 100 is implemented in a non-automotive application, the chassis ground terminal 114 may be the chassis of an electrical system where the chassis is coupled to the Earth. In the example of FIG. 1, the chassis ground terminal 114 is coupled to the first primary side ground terminal, the second primary side ground terminal, and the power status terminal of the gate driver circuit 102. Also, the chassis ground terminal 114 is coupled to the ground terminal of the processor circuit 104 and the second terminal of the first capacitor 108.

In the illustrated example of FIG. 1, the current sensor 116 is implemented by at least one of analog circuitry or digital circuitry. In the example of FIG. 1, the supply terminal of the current sensor 116 is coupled to the second terminal of the second capacitor 118, the second terminal of the third capacitor 120, and the second secondary supply terminal of the gate driver circuit 102. In the example of FIG. 1, the ground terminal of the current sensor 116 is coupled to the first secondary side ground terminal and the second secondary side ground terminal of the gate driver circuit 102. Also, the ground terminal of the current sensor 116 is coupled to the negative input terminal of the current sensor 116, the first terminal of the third capacitor 120, the second terminal of the fourth resistor 124, the second terminal of the fifth resistor 126, the second terminal of the sixth resistor 128, and the first terminal of the load 132.

In the illustrated example of FIG. 1, the positive input terminal of the current sensor 116 is coupled to the source terminal of the switch 106 and the first terminal of the sixth resistor 128. Also, the negative input terminal of the current sensor 116 is coupled to the first secondary side ground terminal and the second secondary side ground terminal of the gate driver circuit 102. Also, the negative input terminal of the current sensor 116 is coupled to the ground terminal of the current sensor 116, the first terminal of the third capacitor 120, the second terminal of the fourth resistor 124, the second terminal of the fifth resistor 126, the second terminal of the sixth resistor 128, and the first terminal of the load 132. In the example of FIG. 1, the output terminal of the current sensor 116 is coupled to the alarm comparator terminal of the gate driver circuit 102 and the second terminal of the third resistor 122.

In the illustrated example of FIG. 1, the first terminal of the second capacitor 118 is coupled to the first secondary supply terminal of the gate driver circuit 102. Also, the second terminal of the second capacitor 118 is coupled to the second secondary supply terminal of the gate driver circuit 102, the supply terminal of the current sensor 116, and the second terminal of the third capacitor 120. In the example of FIG. 1, the first terminal of the third capacitor 120 is coupled to the first secondary side ground terminal and the second secondary side ground terminal of the gate driver circuit 102. Also, the first terminal of the third capacitor 120 is coupled to the ground terminal of the current sensor 116, the negative input terminal of the current sensor 116, the second terminal of the fourth resistor 124, the second terminal of the fifth resistor 126, the second terminal of the sixth resistor 128, and the first terminal of the load 132.

In the illustrated example of FIG. 1, the first terminal of the third resistor 122 is coupled to the fault comparator terminal of the gate driver circuit 102. Also, the first terminal of the third resistor 122 is coupled to the first terminal of the fourth resistor 124. In the example of FIG. 1, the second terminal of the third resistor 122 is coupled to the alarm comparator terminal of the gate driver circuit 102. Also, the second terminal of the third resistor 122 is coupled to the output terminal of the current sensor 116.

In the illustrated example of FIG. 1, the first terminal of the fourth resistor 124 is coupled to the fault comparator terminal of the gate driver circuit 102 and the first terminal of the third resistor 122. In the example of FIG. 1, the second terminal of the fourth resistor 124 is coupled to the first secondary side ground terminal and the second secondary side ground terminal of the gate driver circuit 102. Also, the second terminal of the fourth resistor 124 is coupled to the ground terminal of the current sensor 116, the negative input terminal of the current sensor 116, the first terminal of the third capacitor 120, the second terminal of the fifth resistor 126, the second terminal of the sixth resistor 128, and the first terminal of the load 132.

In the illustrated example of FIG. 1, the first terminal of the fifth resistor 126 is coupled to the response control terminal of the gate driver circuit 102. In the example of FIG. 1, the second terminal of the fifth resistor 126 is coupled to the first secondary side ground terminal and the second secondary side ground terminal of the gate driver circuit 102. Also, the second terminal of the fifth resistor 126 is coupled to the ground terminal of the current sensor 116, the negative input terminal of the current sensor 116, the first terminal of the third capacitor 120, the second terminal of the fourth resistor 124, the second terminal of the sixth resistor 128, and the first terminal of the load 132.

In the illustrated example of FIG. 1, the first terminal of the sixth resistor 128 is coupled to the source terminal of the switch 106 and the positive input terminal of the current sensor 116. In the example of FIG. 1, the second terminal of the sixth resistor 128 is coupled to the first secondary side ground terminal and the second secondary side ground terminal of the gate driver circuit 102. Also, the second terminal of the sixth resistor 128 is coupled to the ground terminal of the current sensor 116, the negative input terminal of the current sensor 116, the first terminal of the third capacitor 120, the second terminal of the fourth resistor 124, the second terminal of the fifth resistor 126, and the first terminal of the load 132.

In the illustrated example of FIG. 1, the power source 130 is implemented by one or more batteries. Example batteries include lithium-ion batteries, nickel-cadmium batteries, nickel-metal hydride batteries, and lead-acid batteries. In some examples, the power source 130 is implemented by one or more ultracapacitors. In some examples, the power source 130 is implemented by an alternating current (AC) to direct current (DC) power converter (e.g., an AC-to-DC converter, a rectifier, etc.). In the example of FIG. 1, the positive terminal of the power source 130 is coupled to the drain terminal of the switch 106. Also, the negative terminal of the power source 130 is coupled to the second terminal of the load 132 and the signal ground terminal 134.

In the illustrated example of FIG. 1, the load 132 is an electrical load such as a resistive load, an inductive load, or a capacitive load. Example resistive loads include household appliances such as incandescent lights, toasters, ovens, space heaters, and coffee makers, among others. Example inductive loads include motors, solenoids, contactor coils, compressors, speakers, relays, transformers, inductors, and power generators, among others. Example capacitive loads include capacitor banks, cables, and batteries, among others.

In the illustrated example of FIG. 1, the first terminal of the load 132 is coupled to the first secondary side ground terminal and the second secondary side ground terminal of the gate driver circuit 102. Also, the first terminal of the load 132 is coupled to the ground terminal of the current sensor 116, the negative input terminal of the current sensor 116, the first terminal of the third capacitor 120, the second terminal of the fourth resistor 124, the second terminal of the fifth resistor 126, and the second terminal of the sixth resistor 128. In the example of FIG. 1, the second terminal of the load 132 is coupled to the negative terminal of the power source 130 and the signal ground terminal 134.

In the illustrated example of FIG. 1, the signal ground terminal 134 is a common terminal from which signals are measured on the secondary side of the isolation barrier 140. In the example of FIG. 1, the signal ground terminal 134 is coupled to a printed circuit board (PCB) or substrate on which the system 100 is implemented. Also, in the example of FIG. 1, the signal ground terminal 134 is coupled to the negative terminal of the power source 130 and the second terminal of the load 132.

In the illustrated example of FIG. 1, the processor circuit 104 controls the switch 106 utilizing the gate driver circuit 102. As described above, the gate driver circuit 102 includes the isolation barrier 140. In the example of FIG. 1, the isolation barrier 140 provides Galvanic isolation between the first die 136 and the second die 138. As such, the processor circuit 104 is Galvanically isolated from the switch 106. In the example of FIG. 1, the gate driver circuit 102 transfers a power signal and one or more data signals across the isolation barrier 140.

In the illustrated example of FIG. 1, the processor circuit 104 provides a primary data signal (e.g., forward data) and a power signal to the first die 136 at the driver enable terminal and the primary side supply terminal of the gate driver circuit 102, respectively. In the example of FIG. 1, the primary data signal corresponds to a control signal to cause the gate driver circuit 102 to drive the switch 106 at the driver terminal of the gate driver circuit 102. For example, the gate driver circuit 102 transfers the power signal across the isolation barrier 140 to power circuitry of the second die 138 and transfers the control signal across the isolation barrier 140 to cause circuitry of the second die 138 to drive the switch 106. In some examples, the primary data signal is serialized using a clock signal generated by an internal clock of the first die 136 of the gate driver circuit 102.

In the illustrated example of FIG. 1, the processor circuit 104 controls the switch 106 utilizing the gate driver circuit 102 to provide over-current protection for the switch 106. For example, the gate driver circuit 102 interfaces with the current sensor 116. In the example of FIG. 1, the gate driver circuit 102 provides the power signal to the current sensor 116 and supporting circuitry at the second secondary supply terminal of the gate driver circuit 102. In the example of FIG. 1, the current sensor 116 amplifies the voltage across the sixth resistor 128 during load conditions to generate an output indicative of the current flowing through the sixth resistor 128.

In the illustrated example of FIG. 1, the gate driver circuit 102 monitors the output of the current sensor 116. In the example of FIG. 1, based on the output of the current sensor 116, the gate driver circuit 102 transfers a secondary data signal (e.g., backward data) over the isolation barrier 140 from the second die 138 to the first die 136. For example, the secondary data signal can include diagnostic data, data specifying one or more operating parameters at the second die 138, data required for power control at the first die 136, DC-to-DC regulation control, etc. In some examples, the secondary data signal is serialized using a clock signal generated by an internal clock implemented on the second die 138 of the gate driver circuit 102. As such, the gate driver circuit 102 can provide a warning to the processor circuit 104 via the alarm terminal. In some examples, the gate driver circuit 102 monitors the output of the current sensor 116 to detect an over-current event. Accordingly, the gate driver circuit 102 can disable (e.g., open) the switch 106 when the output of the current sensor 116 satisfies (e.g., exceeds) an over-current threshold. Also, the gate driver circuit 102 notifies the processor circuit 104 via at least one of the alarm terminal or the fault terminal.

Advantageously, the gate driver circuit 102 transfers the power signal, the primary data signal, and the secondary data signal over the isolation barrier 140 via a single isolation channel. In the example of FIG. 1, the gate driver circuit 102 transfers the power signal, the primary data signal, and the secondary data signal via the single isolation channel in a time-multiplexed manner. For example, transmission of the primary data signal (e.g., the forward data), the power signal, and the secondary data signal (e.g., the background data) over a single isolation channel of the isolation barrier 140 is synchronized in time. Accordingly, circuitry of the first die 136 is structured to drive an isolation channel at times when the primary data signal (e.g., the forward data) is to be transferred from the first die 136 to the second die 138 and at other times when the power signal is to be transferred from the first die 136 to the second die 138. Also, circuitry of the second die 138 is structured to synchronize the timing of transmission of the secondary data signal (e.g., the backward data) over the same isolation channel with respect to the timing of the primary data signal (e.g., the forward data) and the power signal, such as according to a prescribed timing schedule. By utilizing a single isolation channel, both data (e.g., forward data and backward data) and power are transferred over the same isolation channel, thereby eliminating the need for multiple isolation channels to transfer multiple signals.

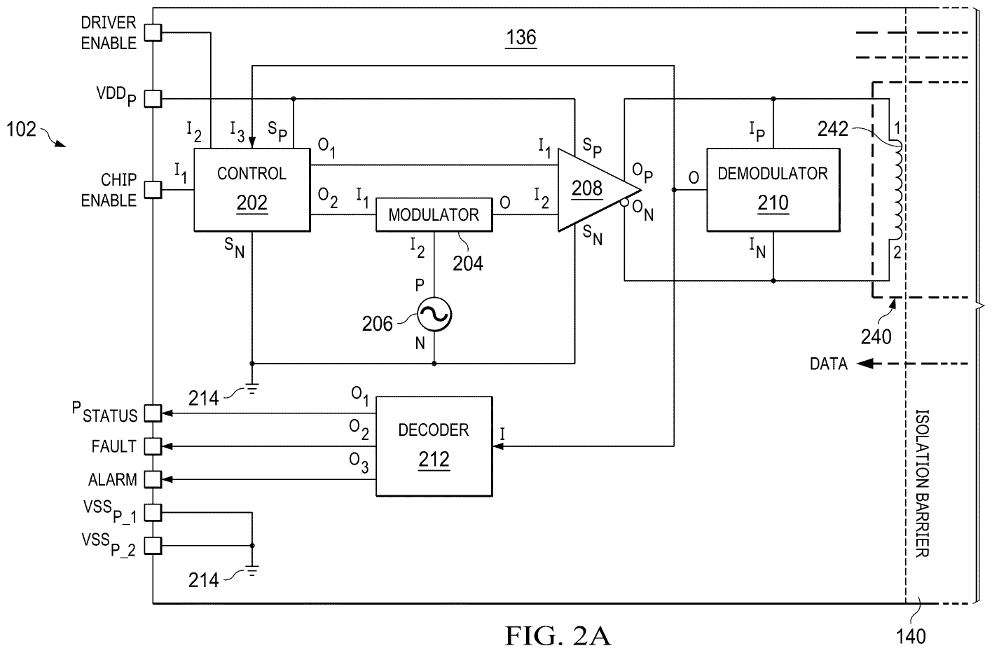

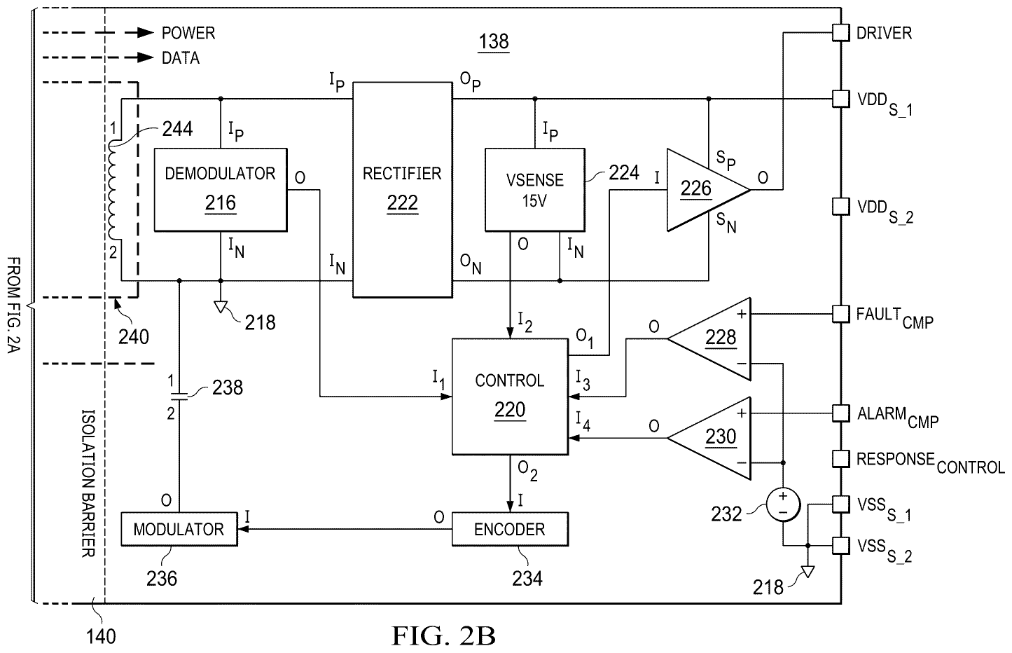

FIGS. 2A and 2B is a block diagram of an example implementation of the gate driver circuit 102 of FIG. 1. As described above, the gate driver circuit 102 includes the first die 136, the second die 138, and the isolation barrier 140. In the example of FIGS. 2A and 2B, the first die 136 includes first example control circuitry 202, first example modulator circuitry 204, example carrier signal generator circuitry 206, example excitation driver circuitry 208, first example demodulator circuitry 210, example decoder circuitry 212, and a first example ground terminal 214.

In the illustrated example of FIGS. 2A and 2B, the second die 138 includes second example demodulator circuitry 216, a second example ground terminal 218, second example control circuitry 220, example rectifier circuitry 222, example voltage sensing circuitry 224, example gate driver circuitry 226, a first example comparator 228, a second example comparator 230, an example reference voltage source 232, example encoder circuitry 234, second modulator circuitry 236, and an example capacitor 238. In the example of FIGS. 2A and 2B, the isolation barrier 140 includes an example isolation channel 240. Also, in the example of FIGS. 2A and 2B, the isolation channel 240 is implemented by a transformer and has an example primary coil 242 and an example secondary coil 244.

In the illustrated example of FIGS. 2A and 2B, at least one of the first die 136 or the second die 138 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of instructions to perform operations. Some or all of the circuitry of FIGS. 2A and 2B may, thus, be instantiated at the same or different times. Also or alternatively, at least one of the first die 136 or the second die 138 may be instantiated (e.g., creating an instance of, bring into being for any length of time, materialize, implement, etc.) by programmable circuitry such as a Central Processor Unit (CPU) executing the instructions. Some or all of the circuitry of FIGS. 2A and 2B may be instantiated, for example, in one or more threads executing concurrently on hardware or in series on hardware.

In the illustrated example of FIGS. 2A and 2B, the first control circuitry 202 has a first input terminal, a second input terminal, a third input terminal, a first output terminal, a second output terminal, a positive supply terminal, and a negative supply terminal. Also, in the example of FIGS. 2A and 2B, the first modulator circuitry 204 has a first input terminal, a second input terminal, and an output terminal. In the example of FIGS. 2A and 2B, the carrier signal generator circuitry 206 has a positive terminal and a negative terminal. Also, the excitation driver circuitry 208 has a first input terminal, a second input terminal, a positive output terminal, a negative output terminal, a positive supply terminal, and a negative supply terminal. In the example of FIGS. 2A and 2B, the first demodulator circuitry 210 has a positive input terminal, a negative input terminal, and an output terminal. Also, in the example of FIGS. 2A and 2B, the decoder circuitry 212 has an input terminal, a first output terminal, a second output terminal, and a third output terminal.

In the illustrated example of FIGS. 2A and 2B, the second demodulator circuitry 216 has a positive input terminal, a negative input terminal, and an output terminal. Also, the second control circuitry 220 has a first input terminal, a second input terminal, a third input terminal, a fourth input terminal, a first output terminal, and a second output terminal. In the example of FIGS. 2A and 2B, the rectifier circuitry 222 has a positive input terminal, a negative input terminal, a positive output terminal, and a negative output terminal. Also, the voltage sensing circuitry 224 has a positive input terminal, a negative input terminal, and an output terminal. In the example of FIGS. 2A and 2B, the gate driver circuitry 226 has an input terminal, an output terminal, a positive supply terminal, and a negative supply terminal.

In the illustrated example of FIGS. 2A and 2B, each of the first comparator 228 and the second comparator 230 has a non-inverting input terminal, an inverting input terminal, and an output terminal. Also, the reference voltage source 232 has a positive terminal and a negative terminal. In the example of FIGS. 2A and 2B, each of the encoder circuitry 234 and the second modulator circuitry 236 has an input terminal and an output terminal. Also, the capacitor 238 has a first terminal and a second terminal. In the example of FIGS. 2A and 2B, each of the primary coil 242 and the secondary coil 244 has a first terminal and a second terminal.

In the illustrated example of FIGS. 2A and 2B, the first control circuitry 202 is implemented by at least one of analog circuitry or digital circuitry. In the example of FIGS. 2A and 2B, the first input terminal of the first control circuitry 202 is coupled to the chip enable terminal of the gate driver circuit 102. Also, the second input terminal of the first control circuitry 202 is coupled to the driver enable terminal of the gate driver circuit 102. In the example of FIGS. 2A and 2B, the third input terminal of the first control circuitry 202 is coupled to the output terminal of the first demodulator circuitry 210 and the input terminal of the decoder circuitry 212.

In the illustrated example of FIGS. 2A and 2B, the first output terminal of the first control circuitry 202 is coupled to the first input terminal of the excitation driver circuitry 208. In the example of FIGS. 2A and 2B, the second output terminal of the first control circuitry 202 is coupled to the first input terminal of the first modulator circuitry 204. Also, the positive supply terminal of the first control circuitry 202 is coupled to the primary side supply terminal of the gate driver circuit 102 and the positive supply terminal of the excitation driver circuitry 208. In the example of FIGS. 2A and 2B, the negative supply terminal of the first control circuitry 202 is coupled to the first primary side ground terminal of the gate driver circuit 102, the second primary side ground terminal of the gate driver circuit 102, the negative terminal of the carrier signal generator circuitry 206, the negative supply terminal of the excitation driver circuitry 208, and the first ground terminal 214.

In the illustrated example of FIGS. 2A and 2B, the first modulator circuitry 204 is implemented by at least one of analog circuitry or digital circuitry. In the example of FIGS. 2A and 2B, the first input terminal of the first modulator circuitry 204 is coupled to the second output terminal of the first control circuitry 202. Also, the second input terminal of the first modulator circuitry 204 is coupled to the positive terminal of the carrier signal generator circuitry 206. In the example of FIGS. 2A and 2B, the output terminal of the first modulator circuitry 204 is coupled to the second input terminal of the excitation driver circuitry 208.

In the illustrated example of FIGS. 2A and 2B, the carrier signal generator circuitry 206 is implemented by at least one of analog circuitry or digital circuitry. In the example of FIGS. 2A and 2B, the positive terminal of the carrier signal generator circuitry 206 is coupled to the second input terminal of the first modulator circuitry 204. Also, the negative terminal of the carrier signal generator circuitry 206 is coupled to the first primary side ground terminal of the gate driver circuit 102, the second primary side ground terminal of the gate driver circuit 102, the negative supply terminal of the first control circuitry 202, the negative supply terminal of the excitation driver circuitry 208, and the first ground terminal 214.

In the illustrated example of FIGS. 2A and 2B, the excitation driver circuitry 208 is implemented by at least one of analog circuitry or digital circuitry. For example, the excitation driver circuitry 208 is structured to operate, based on a control signal from the first control circuitry 202, as a passthrough circuit and a converter to convert a DC power signal at the primary side supply terminal of the gate driver circuit 102 to an AC power signal. In the example of FIGS. 2A and 2B, the first input terminal of the excitation driver circuitry 208 is coupled to the first output terminal of the first control circuitry 202. Also, the second input terminal of the excitation driver circuitry 208 is coupled to the output terminal of the first modulator circuitry 204. In the example of FIGS. 2A and 2B, the positive output terminal of the excitation driver circuitry 208 is coupled to the positive input terminal of the first demodulator circuitry 210 and the first terminal of the primary coil 242. Also, the negative output terminal of the excitation driver circuitry 208 is coupled to the negative input terminal of the first demodulator circuitry 210 and the second terminal of the primary coil 242.

In the illustrated example of FIGS. 2A and 2B, the positive supply terminal of the excitation driver circuitry 208 is coupled to the primary side supply terminal of the gate driver circuit 102 and the positive supply terminal of the first control circuitry 202. In the example of FIGS. 2A and 2B, the negative supply terminal of the excitation driver circuitry 208 is coupled to the first primary side ground terminal of the gate driver circuit 102 and the second primary side ground terminal of the gate driver circuit 102. Also, the negative supply terminal of the excitation driver circuitry 208 is coupled to the negative supply terminal of the first control circuitry 202, the negative terminal of the carrier signal generator circuitry 206, and the first ground terminal 214.

In the illustrated example of FIGS. 2A and 2B, the first demodulator circuitry 210 is implemented by at least one of analog circuitry or digital circuitry. In the example of FIGS. 2A and 2B, the positive input terminal of the first demodulator circuitry 210 is coupled to the positive output terminal of the excitation driver circuitry 208 and the first terminal of the primary coil 242. Also, the negative input terminal of the first demodulator circuitry 210 is coupled to the negative output terminal of the excitation driver circuitry 208 and the second terminal of the primary coil 242.

In the illustrated example of FIGS. 2A and 2B, the decoder circuitry 212 is implemented by at least one of analog circuitry or digital circuitry. In the example of FIGS. 2A and 2B, the input terminal of the decoder circuitry 212 is coupled to the output terminal of the first demodulator circuitry 210 and the third input terminal of the first control circuitry 202. Also, the first output terminal of the decoder circuitry 212 is coupled to the power status terminal of the gate driver circuit 102.

In the illustrated example of FIGS. 2A and 2B, the second output terminal of the decoder circuitry 212 is coupled to the fault terminal of the gate driver circuit 102. In the example of FIGS. 2A and 2B, the third output terminal of the decoder circuitry 212 is coupled to the alarm terminal of the gate driver circuit 102. Also, the first ground terminal 214 is coupled to the first primary side ground terminal of the gate driver circuit 102, the second primary side ground terminal of the gate driver circuit 102, the negative supply terminal of the first control circuitry 202, the negative terminal of the carrier signal generator circuitry 206, and the negative supply terminal of the excitation driver circuitry 208.

In the illustrated example of FIGS. 2A and 2B, the second demodulator circuitry 216 is implemented by at least one of analog circuitry or digital circuitry. In the example of FIGS. 2A and 2B, the positive input terminal of the second demodulator circuitry 216 is coupled to the first terminal of the secondary coil 244 and the positive input terminal of the rectifier circuitry 222. Also, the negative input terminal of the second demodulator circuitry 216 is coupled to the first secondary side ground terminal of the gate driver circuit 102, the second secondary side ground terminal of the gate driver circuit 102, the second ground terminal 218, the negative input terminal of the rectifier circuitry 222, the negative terminal of the reference voltage source 232, the first terminal of the capacitor 238, and the second terminal of the secondary coil 244. In the example of FIGS. 2A and 2B, the output terminal of the second demodulator circuitry 216 is coupled to the first input terminal of the second control circuitry 220. Also, the second ground terminal 218 is coupled to the first secondary side ground terminal of the gate driver circuit 102, the second secondary side ground terminal of the gate driver circuit 102, the negative input terminal of the second demodulator circuitry 216, the negative input terminal of the rectifier circuitry 222, the negative terminal of the reference voltage source 232, the first terminal of the capacitor 238, and the second terminal of the secondary coil 244.

In the illustrated example of FIGS. 2A and 2B, the second control circuitry 220 is implemented by at least one of analog circuitry or digital circuitry. In the example of FIGS. 2A and 2B, the first input terminal of the second control circuitry 220 is coupled to the output terminal of the second demodulator circuitry 216. Also, the second input terminal of the second control circuitry 220 is coupled to the output terminal of the voltage sensing circuitry 224. In the example of FIGS. 2A and 2B, the third input terminal of the second control circuitry 220 is coupled to the output terminal of the first comparator 228. Also, the fourth input terminal of the second control circuitry 220 is coupled to the output terminal of the second comparator 230. In the example of FIGS. 2A and 2B, the first output terminal of the second control circuitry 220 is coupled to the input terminal of the gate driver circuitry 226. In the example of FIGS. 2A and 2B, the second output terminal of the second control circuitry 220 is coupled to the input terminal of the encoder circuitry 234.

In the illustrated example of FIGS. 2A and 2B, the rectifier circuitry 222 is implemented by at least one of analog circuitry or digital circuitry. In the example of FIGS. 2A and 2B, the positive input terminal of the rectifier circuitry 222 is coupled to the first terminal of the secondary coil 244 and the positive input terminal of the second demodulator circuitry 216. Also, the negative input terminal of the rectifier circuitry 222 is coupled to the first secondary side ground terminal of the gate driver circuit 102, the second secondary side ground terminal of the gate driver circuit 102, the negative input terminal of the second demodulator circuitry 216, the second ground terminal 218, the negative terminal of the reference voltage source 232, the first terminal of the capacitor 238, and the second terminal of the secondary coil 244. In the example of FIGS. 2A and 2B, the positive output terminal of the rectifier circuitry 222 is coupled to the positive input terminal of the voltage sensing circuitry 224, the positive supply terminal of the gate driver circuitry 226, and the first secondary supply terminal of the gate driver circuit 102. Also, the negative output terminal of the rectifier circuitry 222 is coupled to the negative input terminal of the voltage sensing circuitry 224 and the negative supply terminal of the gate driver circuitry 226.

In the illustrated example of FIGS. 2A and 2B, the voltage sensing circuitry 224 is implemented by at least one of analog circuitry or digital circuitry. In the example of FIGS. 2A and 2B, the positive input terminal of the voltage sensing circuitry 224 is coupled to the positive output terminal of the rectifier circuitry 222, the positive supply terminal of the gate driver circuitry 226, and the first secondary supply terminal of the gate driver circuit 102. Also, the negative input terminal of the voltage sensing circuitry 224 is coupled to the negative output terminal of the rectifier circuitry 222 and the negative supply terminal of the gate driver circuitry 226. In the example of FIGS. 2A and 2B, the output terminal of the voltage sensing circuitry 224 is coupled to the second input terminal of the second control circuitry 220.

In the illustrated example of FIGS. 2A and 2B, the gate driver circuitry 226 is implemented by at least one of analog circuitry or digital circuitry. In the example of FIGS. 2A and 2B, the input terminal of the gate driver circuitry 226 is coupled to the first output terminal of the second control circuitry 220. Also, the output terminal of the gate driver circuitry 226 is coupled to the driver terminal of the gate driver circuit 102. In the example of FIGS. 2A and 2B, the positive supply terminal of the gate driver circuitry 226 is coupled to the positive output terminal of the rectifier circuitry 222, the positive input terminal of the voltage sensing circuitry 224, and the first secondary supply terminal of the gate driver circuit 102. Also, the negative supply terminal of the gate driver circuitry 226 is coupled to the negative output terminal of the rectifier circuitry 222 and the negative input terminal of the voltage sensing circuitry 224.

In the illustrated example of FIGS. 2A and 2B, the first comparator 228 is implemented by at least one of analog circuitry or digital circuitry. In some examples, the first comparator 228 is referred to as first comparator circuitry. In the example of FIGS. 2A and 2B, the non-inverting input terminal of the first comparator 228 is coupled to the fault comparator terminal of the gate driver circuit 102. Also, the inverting input terminal of the first comparator 228 is coupled to the positive terminal of the reference voltage source 232 and the inverting input terminal of the second comparator 230. In the example of FIGS. 2A and 2B, the output terminal of the first comparator 228 is coupled to the third input terminal of the second control circuitry 220.

In the illustrated example of FIGS. 2A and 2B, the second comparator 230 is implemented by at least one of analog circuitry or digital circuitry. In some examples, the second comparator 230 is referred to as second comparator circuitry. In the example of FIGS. 2A and 2B, the non-inverting input terminal of the second comparator 230 is coupled to the alarm comparator terminal of the gate driver circuit 102. Also, the inverting input terminal of the second comparator 230 is coupled to the positive terminal of the reference voltage source 232 and the inverting input terminal of the first comparator 228. In the example of FIGS. 2A and 2B, the output terminal of the second comparator 230 is coupled to the fourth input terminal of the second control circuitry 220.

In the illustrated example of FIGS. 2A and 2B, the reference voltage source 232 is implemented by at least one of analog circuitry or digital circuitry. In the example of FIGS. 2A and 2B, the positive terminal of the reference voltage source 232 is coupled to the inverting input terminal of the first comparator 228 and the inverting input terminal of the second comparator 230. Also, the negative terminal of the reference voltage source 232 is coupled to the first secondary side ground terminal of the gate driver circuit 102, the second secondary side ground terminal of the gate driver circuit 102, the negative input terminal of the second demodulator circuitry 216, the second ground terminal 218, the negative input terminal of the rectifier circuitry 222, the first terminal of the capacitor 238, and the second terminal of the secondary coil 244.

In the illustrated example of FIGS. 2A and 2B, the encoder circuitry 234 is implemented by at least one of analog circuitry or digital circuitry. In the example of FIGS. 2A and 2B, the input terminal of the encoder circuitry 234 is coupled to the second output terminal of the second control circuitry 220. Also, the output terminal of the encoder circuitry 234 is coupled to the input terminal of the second modulator circuitry 236.

In the illustrated example of FIGS. 2A and 2B, the second modulator circuitry 236 is implemented by at least one of analog circuitry or digital circuitry. In the example of FIGS. 2A and 2B, the input terminal of the second modulator circuitry 236 is coupled to the output terminal of the encoder circuitry 234. Also, the output terminal of the second modulator circuitry 236 is coupled to the second terminal of the capacitor 238. In the example of FIGS. 2A and 2B, the first terminal of the capacitor 238 is coupled to the first secondary side ground terminal of the gate driver circuit 102, the second secondary side ground terminal of the gate driver circuit 102, the negative input terminal of the second demodulator circuitry 216, the second ground terminal 218, the negative input terminal of the rectifier circuitry 222, the negative terminal of the reference voltage source 232, and the second terminal of the secondary coil 244. Also, the second terminal of the capacitor 238 is coupled to the output terminal of the second modulator circuitry 236.

As described above, the isolation channel 240 is implemented by a transformer that has the primary coil 242 and the secondary coil 244. In the example of FIGS. 2A and 2B, the primary coil 242 and the secondary coil 244 are inductively coupled to one another. Also, the first terminal of the primary coil 242 is coupled to the positive output terminal of the excitation driver circuitry 208 and the positive input terminal of the first demodulator circuitry 210. In the example of FIGS. 2A and 2B, the second terminal of the primary coil 242 is coupled to the negative output terminal of the excitation driver circuitry 208 and the negative input terminal of the first demodulator circuitry 210.

In the illustrated example of FIGS. 2A and 2B, the first terminal of the secondary coil 244 is coupled to the positive input terminal of the second demodulator circuitry 216 and the positive input terminal of the rectifier circuitry 222. In the example of FIGS. 2A and 2B, the second terminal of the secondary coil 244 is coupled to the first secondary side ground terminal of the gate driver circuit 102, the second secondary side ground terminal of the gate driver circuit 102, the second ground terminal 218, and the negative terminal of the reference voltage source 232. Also, the second terminal of the secondary coil 244 is coupled to the negative input terminal of the second demodulator circuitry 216, the negative input terminal of the rectifier circuitry 222, and the first terminal of the capacitor 238.

In the illustrated example of FIGS. 2A and 2B, during initial startup of the gate driver circuit 102, power is transmitted across the isolation barrier 140 to charge at least one capacitor coupled to the second die 138 (e.g., the second capacitor 118 and the third capacitor 120). As such, the second die 138 remains powered during periods when data is communicated over the isolation barrier 140 as described above. During nominal operation, the first control circuitry 202 operates based on signals at the driver enable terminal, the primary side supply terminal, and the chip enable terminal of the gate driver circuit 102. For example, when the signal at the chip enable terminal is a logic high value (e.g., 5 volts (V)) and the signal at the primary side supply terminal is at a supply voltage (e.g., 5 V), the first control circuitry 202 is enabled.

In the illustrated example of FIGS. 2A and 2B, when enabled, the first control circuitry 202 causes periodic communication between the first die 136 and the second die 138 based on the signal at the driver enable terminal of the gate driver circuit 102. For example, each period of communication includes a first sub-period during which a primary data signal is communicated from the first die 136 to the second die 138, a second sub-period during which a secondary data signal is communicated from the second die 138 to the first die 136, a third sub-period during which a power signal is transferred from the first die 136 to the second die 138, and a fourth sub-period during which the isolation channel 240 is idle. In the example of FIGS. 2A and 2B, the first control circuitry 202 maintains one or more timers corresponding to the first sub-period, the second sub-period, the third sub-period, and the fourth sub-period. For example, the first control circuitry 202 maintains a first timer indicative of the end of the first sub-period, a second timer indicative of the end of the second sub-period, a third timer indicative of the end of the third sub-period, and a fourth timer indicative of the end of the fourth sub-period.

In the illustrated example of FIGS. 2A and 2B, when the primary side supply terminal is at a supply voltage (e.g., 5 V), the excitation driver circuitry 208 is enabled and energizes the primary coil 242 based on a signal (e.g., a carrier signal, a modulated carrier signal, a power signal, etc.). In the example of FIGS. 2A and 2B, based on a logic high value (e.g., 5 V) at the driver enable terminal of the gate driver circuit 102, the first control circuitry 202 initiates periodic communication between the first die 136 and the second die 138. For example, during the first sub-period of periodic communication, the first control circuitry 202 sends a primary data signal (e.g., a forward data signal, a control data signal, etc.) to the first modulator circuitry 204 to be modulated into a carrier signal generated by the carrier signal generator circuitry 206. For example, the primary data signal is a 1-bit signal. Also, during the first sub-period, the first modulator circuitry 204 modulates the carrier signal based on the primary data signal to produce a modulated carrier signal. For example, the first modulator circuitry 204 modulates the carrier signal based on the primary data signal utilizing amplitude modulation. In some examples, the first modulator circuitry 204 utilizes another type of modulation (e.g., frequency modulation, phase modulation, etc.).

In the illustrated example of FIGS. 2A and 2B, after modulating the carrier signal, the first modulator circuitry 204 sends the modulated carrier signal to the excitation driver circuitry 208. In the example of FIGS. 2A and 2B, based on a control signal generated by the first control circuitry 202, the excitation driver circuitry 208 energizes the primary coil 242 based on the modulated carrier signal to communicate the primary data signal (e.g., the forward data signal, the control data signal, etc.) to the second die 138. For example, the excitation driver circuitry 208 operates at a high frequency (e.g., the frequency of the carrier signal). For example, the excitation driver circuitry 208 operates at 80 megahertz (MHz). In the example of FIGS. 2A and 2B, the second demodulator circuitry 216 demodulates a signal received at the secondary coil 244 to obtain the primary data signal (e.g., the forward data signal, the control data signal, etc.). For example, the second demodulator circuitry 216 demodulates the signal received at the secondary coil 244 utilizing amplitude modulation. In some examples, the second demodulator circuitry 216 utilizes another type of modulation (e.g., frequency modulation, phase modulation, etc.). After demodulating the signal received at the secondary coil 244 to obtain the primary data signal, the second demodulator circuitry 216 communicates the primary data signal to the second control circuitry 220.

In the illustrated example of FIGS. 2A and 2B, the primary data signal indicates to the second control circuitry 220 whether a switch is to be driven (e.g., the gate terminal of the switch is to be energized). For example, the primary data signal communicates switch enable (EN) state information for the switch 106. In the example of FIGS. 2A and 2B, the second control circuitry 220 sends a control signal to the gate driver circuitry 226 to cause the gate driver circuitry 226 to assert a signal at the driver terminal of the gate driver circuit 102 based on the state information included in the primary data signal. Also, the second control circuitry 220 maintains a timer corresponding to the primary data signal. In the example of FIGS. 2A and 2B, the timer is indicative of the end of the first sub-period of a communication period. For example, the timer measures a period between the start of the second sub-period of a first communication period and the end of the first sub-period of a second communication period. Based on expiration of the timer, the second control circuitry 220 initiates the second sub-period of periodic communication.

In the illustrated example of FIGS. 2A and 2B, the second die 138 includes the voltage sensing circuitry 224, the first comparator 228, and the second comparator 230 as described above. In the example of FIGS. 2A and 2B, the voltage sensing circuitry 224 monitors the voltage at the first secondary side supply terminal of the gate driver circuit 102. In some examples, the voltage sensing circuitry 224 monitors the voltage at the second secondary side supply terminal. Based on the voltage at one or more of the first secondary side supply terminal or the second secondary side supply terminal, the voltage sensing circuitry 224 generates a power status signal indicative of whether the voltage at one or more of the first secondary side supply terminal or the second secondary side supply terminal has satisfied (e.g., is less than, is less than or equal to, etc.) a low voltage threshold.

For example, if the voltage at one or more of the first secondary side supply terminal or the second secondary side supply terminal satisfies the low voltage threshold, the voltage sensing circuitry 224 outputs the power status signal as a logic high value (e.g., 5 V, a 1, etc.) to indicate a low power condition associated with the gate driver circuit 102. Also, for example, if the voltage at one or more of the first secondary side supply terminal or the second secondary side supply terminal does not satisfy the low voltage threshold, the voltage sensing circuitry 224 outputs the power status signal as a logic low value (e.g., 0 V, a 0, etc.) to indicate the lack of a low power condition associated with the gate driver circuit 102. Based on the power status signal, the second control circuitry 220 communicates a power state to the encoder circuitry 234.

In the illustrated example of FIGS. 2A and 2B, the non-inverting input terminal of the first comparator 228 monitors the voltage at the fault comparator terminal of the gate driver circuit 102. For example, the fault comparator terminal of the gate driver circuit 102 receives a signal output from the current sensor 116. In the example of FIGS. 2A and 2B, the first comparator 228 compares the voltage at the fault comparator terminal of the gate driver circuit 102 to the reference voltage generated by the reference voltage source 232. Based on the comparison, the first comparator 228 outputs a fault signal to the second control circuitry 220.

For example, if the voltage at the fault comparator terminal satisfies (e.g., is greater than, is greater than or equal to, etc.) the reference voltage, the first comparator 228 outputs the fault signal as a logic high value (e.g., 5 V, a 1, etc.) to indicate a fault condition associated with a power switch (e.g., the switch 106) managed by the gate driver circuit 102. Also, for example, if the voltage at the fault comparator terminal does not satisfy (e.g., is less than) the reference voltage, the first comparator 228 outputs the fault signal as a logic low value (e.g., 0 V, a 0, etc.) to indicate the lack of a fault condition associated with the power switch. Based on the fault signal indicating a fault condition, the second control circuitry 220 causes the gate driver circuitry 226 to disable (e.g., open) the switch managed by the gate driver circuit 102 regardless of the state information communicated by the primary data signal from the first die 136. As such, the second control circuitry 220 can ensure that a switch (e.g., the switch 106) managed by the gate driver circuit 102 and any downstream circuitry (e.g., the load 132) is protected against dangerous conditions (e.g., over current events).

In the illustrated example of FIGS. 2A and 2B, the non-inverting input terminal of the second comparator 230 monitors the voltage at the alarm comparator terminal of the gate driver circuit 102. For example, the alarm comparator terminal of the gate driver circuit 102 receives a signal output from the current sensor 116. In the example of FIGS. 2A and 2B, the second comparator 230 compares the voltage at the alarm comparator terminal of the gate driver circuit 102 to the reference voltage generated by the reference voltage source 232. Based on the comparison, the second comparator 230 outputs an alarm signal to the second control circuitry 220.

For example, if the voltage at the alarm comparator terminal satisfies (e.g., is greater than, is greater than or equal to, etc.) the reference voltage, the second comparator 230 outputs the alarm signal as a logic high value (e.g., 5 V, a 1, etc.) to indicate an alarm condition associated with a power switch (e.g., the switch 106) managed by the gate driver circuit 102. Also, for example, if the voltage at the alarm comparator terminal does not satisfy (e.g., is less than) the reference voltage, the second comparator 230 outputs the alarm signal as a logic low value (e.g., 0 V, a 0, etc.) to indicate the lack of an alarm condition associated with the power switch. Based on the alarm signal, the second control circuitry 220 communicates an alarm state to the encoder circuitry 234. In the example of FIGS. 2A and 2B, the second control circuitry 220 does not control the gate driver circuitry 226 based on the alarm signal.

As described above, the second control circuitry 220 maintains a timer corresponding to the primary data signal (e.g., indicative of the end of the first sub-period of a communication period). Based on expiration of the timer, the second control circuitry 220 sends at least one of power state information, fault state information, or alarm state information to the first die 136. For example, the second control circuitry 220 sends at least one of the power state information, the fault state information, or the alarm state information to the encoder circuitry 234. In the example of FIGS. 2A and 2B, the power state information, the fault state information, and the alarm state information are based on the power status signal, the fault signal, and the alarm signal, respectively.

In the illustrated example of FIGS. 2A and 2B, the encoder circuitry 234 serializes at least one of the power state information, the fault state information, or the alarm state information to encode at least one of the power state information, the fault state information, or the alarm state information into a secondary data signal (e.g., a backward data signal, a feedback data signal, etc.). For example, the secondary data signal (e.g., the backward data signal, the feedback data signal, etc.) is a serialized data stream of three bits or four bits of data. For example, if the power state information is indicative of the voltage at one of the first secondary side supply terminal or the second secondary side supply terminal, then the secondary data signal is a 3-bit signal where one bit is indicative of the power state information, one bit is indicative of the fault state information, and one bit is indicative of thew alarm state information. Also, for example, if the power state information is indicative of the voltages at the first secondary side supply terminal and the second secondary side supply terminal, then the secondary data signal is a 4-bit signal where two bits are indicative of the power state information, one bit is indicative of the fault state information, and one bit is indicative of thew alarm state information.

In the illustrated example of FIGS. 2A and 2B, the encoder circuitry 234 utilizes synchronous communication based on a frequency of operation of the secondary coil 244. In some examples, the encoder circuitry 234 utilizes asynchronous communication to encode at least one of the power state information, the fault state information, or the alarm state information into the serialized data stream. In the example of FIGS. 2A and 2B, the encoder circuitry 234 sends the secondary data signal to the second modulator circuitry 236.

In the illustrated example of FIGS. 2A and 2B, the second modulator circuitry 236 modulates an impedance of the circuit coupled to the secondary coil 244 over time based on the secondary data signal (e.g., serialized data stream) from the encoder circuitry 234. For example, the second modulator circuitry 236 includes a switch coupled to the second terminal of the capacitor 238 and based on the secondary data signal (e.g., the serialized data steam) enables (e.g., closes) or disables (e.g., opens) the switch. In the example of FIGS. 2A and 2B, when the second modulator circuitry 236 enables the switch, the impedance of the circuit coupled to the secondary coil 244 is a first value and when the second modulator circuitry 236 disables the switch, the impedance of the circuit coupled to the secondary coil 244 is a second value. In this manner, the second modulator circuitry 236 modulates the impedance of the circuit coupled to the secondary coil 244 over time based on the secondary data signal (e.g., the serialized data stream) from the encoder circuitry 234.

As described above, the primary coil 242 and the secondary coil 244 are inductively coupled to one another. As such, a change in the load impedance on the secondary coil 244 is reflected in a change in the input impedance to the primary coil 242. As such, the current on the primary side of the isolation channel 240 varies based on the secondary data signal (e.g., the serialized data stream) from the encoder circuitry 234. On the first die 136, the first demodulator circuitry 210 includes a resistor and measures the voltage across the resistor over time. By tracking the voltage across the resistor of the first demodulator circuitry 210 over time, the first demodulator circuitry 210 demodulates a signal received at the primary coil 242 to obtain the secondary data signal (e.g., the serialized data stream). After obtaining the secondary data signal, the first demodulator circuitry 210 communicates the secondary data signal to the first control circuitry 202 and the decoder circuitry 212.

In the illustrated example of FIGS. 2A and 2B, based on the secondary data signal, the first control circuitry 202 adjusts control of the power switch (e.g., the switch 106) managed by the gate driver circuit 102. Also, based on the secondary data signal, the decoder circuitry 212 deserializes the secondary data signal to obtain at least one of power state information, fault state information, or alarm state information. For example, the decoder circuitry 212 utilizes synchronous communication based on a frequency of operation of the primary coil 242. In some examples, the decoder circuitry 212 utilizes asynchronous communication to decode at least one of the power state information, the fault state information, or the alarm state information from the secondary data signal. In the example of FIGS. 2A and 2B, the decoder circuitry 212 outputs signals (e.g., feedback data signals) at the power status terminal, the fault terminal, and the alarm terminal of the gate driver circuit 102 based on the power state information, the fault state information, and the alarm state information, respectively.

As described above, the first control circuitry 202 maintains a timer corresponding to the second sub-period (e.g., indicative of the end of the second sub-period). Based on expiration of the timer corresponding to the second sub-period, the first control circuitry 202 initiates the third sub-period of periodic communication between the first die 136 and the second die 138. For example, during the third sub-period of periodic communication, the first control circuitry 202 sends a control signal to the excitation driver circuitry 208. In the example of FIGS. 2A and 2B, based on the control signal generated by the first control circuitry 202, the excitation driver circuitry 208 operates as a converter to convert a DC power signal at the primary side supply terminal of the gate driver circuit 102 to an AC power signal. Based on the AC power signal, the excitation driver circuitry 208 energizes the primary coil 242 to transfer power (e.g., a power signal) to the second die 138.

In the illustrated example of FIGS. 2A and 2B, the second die 138 includes the rectifier circuitry 222 as described above. In the example of FIGS. 2A and 2B, the rectifier circuitry 222 rectifies an AC power signal received at the secondary coil 244 into a DC power signal. As such, circuitry disposed on or coupled to the second die 138 is powered. For example, based on the DC power signal output from the rectifier circuitry 222, circuitry on the second die 138 is powered. Also, for example, based on the DC power signal output from the rectifier circuitry 222, at least one capacitor coupled to the second die 138 (e.g., the second capacitor 118 and the third capacitor 120) is charged or recharged. As such, the second die 138 remains powered during periods when data is communicated over the isolation channel 240 as described above.

In the illustrated example of FIGS. 2A and 2B, after power has been transferred over the isolation channel 240 (e.g., after a timer corresponding to the third sub-period expires), the first control circuitry 202 causes the excitation driver circuitry 208 to energize the primary coil 242 based on the carrier signal (e.g., without modulation) for the fourth sub-period of periodic communication. For example, the fourth sub-period of periodic communication is a reset period during which circuitry on the first die 136 and the second die 138 can reset for a subsequent communication period. In the example of FIGS. 2A and 2B, after expiration of a timer corresponding to the fourth sub-period, the first control circuitry 202 initiates a first sub-period of a subsequent communication period.

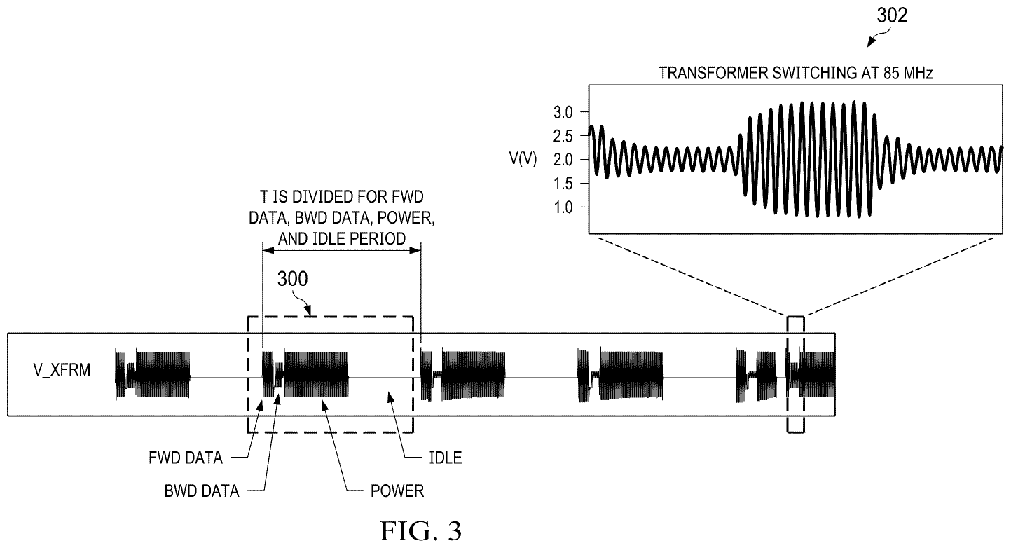

FIG. 3 illustrates an example transmission 300 of forward (FWD) data, backward (BWD) data, and power in a time-multiplexed manner over an isolation channel of the gate driver circuit 102 of FIGS. 2A and 2B. In the example of FIG. 3, the FWD data corresponds to the primary data signal described in FIGS. 1 and 2. Also, for example, the BWD data corresponds to the secondary data signal described in FIGS. 1 and 2. In the example of FIG. 3, power corresponds to the power signal described in FIGS. 1 and 2.

In the illustrated example of FIG. 3, the transmission 300 occurs over a time period of T (e.g., T=25 microseconds (μs)). In the example of FIG. 3, the FWD data is transmitted from the first die 136 to the second die 138 during a first portion (e.g., a first sub-period) of T, the BWD data is transmitted from the second die 138 to the first die 136 during a second portion (e.g., a second sub-period) of T, and the power is transmitted from the first die 136 to the second die 138 during a third portion (e.g., a third sub-period) of T. After power is transmitted, there is an idle portion (e.g., a fourth sub-period) of T until the end of the time period T. In some examples, the FWD data, the BWD data, and the power are at least one of switched or modulated at a clock frequency (e.g., 85 MHz). FIG. 3 also illustrates an enlarged view of the BWD data, shown at 302, which is communicated from the second die 138 at the clock frequency during the second portion (e.g., the second sub-period) of T.

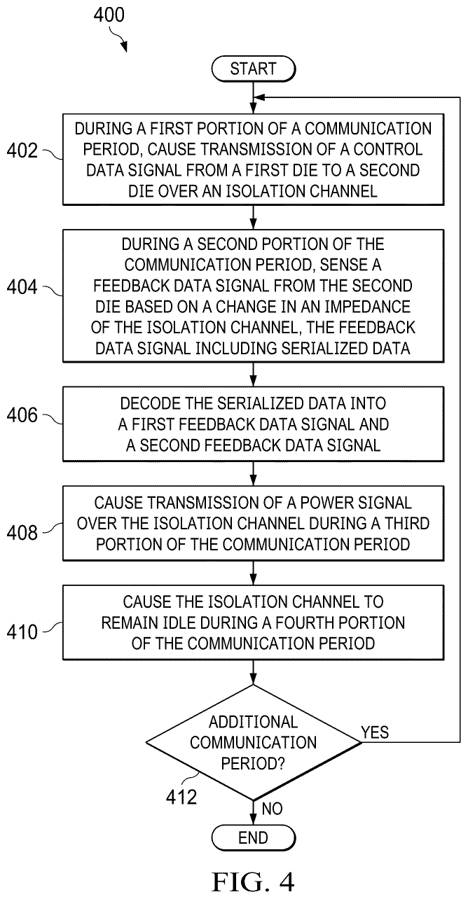

FIG. 4 is a flowchart representative of at least one of example machine-readable instructions or example operations 400 that may be at least one of executed, instantiated, or performed using an example programmable circuitry implementation of the first die 136 of the gate driver circuit 102 of FIGS. 2A and 2B. The at least one of the example machine-readable instructions or the example operations 400 of FIG. 4 begin at block 402, at which control circuitry disposed on the first die 136 causes transmission of a control data signal (e.g., a first type of signal) from the first die 136 to the second die 138 over an isolation channel during a first portion of a communication period. For example, at block 402, the first control circuitry 202 causes transmission (e.g., is to cause transmission) of the control data signal from the first die 136 to the second die 138 over the isolation channel 240 during the first portion of the communication period.

In the illustrated example of FIG. 4, at block 404, during a second portion of the communication period, demodulator circuitry disposed on the first die 136 senses a feedback data signal (e.g., a second type of signal) from the second die 138 based on a change in an impedance of the isolation channel, the feedback data signal including serialized data. For example, at block 404, the first demodulator circuitry 210 senses the feedback data signal from the second die 138 based on a change in an impedance of the isolation channel 240 during the second portion of the communication period. After sensing the feedback data signal, the first demodulator circuitry 210 communicates the feedback data signal to the first control circuitry 202 and the decoder circuitry 212. In this manner, the first control circuitry 202 detects the feedback data signal.

In the illustrated example of FIG. 4, at block 406, decoder circuitry disposed on the first die 136 decodes the serialized data into a first feedback data signal and a second feedback data signal. For example, at block 406, the decoder circuitry 212 decodes the serialized data into a first feedback data signal and a second feedback data signal. In the example of FIG. 4, the first feedback data signal is indicative of a status of a power supply voltage of the second die 138 and the second feedback data signal is indicative of a status (e.g., fault state information, alarm state information, etc.) associated with operation of a power switch to be controlled based on a control signal.

In the illustrated example of FIG. 4, at block 408, the control circuitry disposed on the first die 136 causes transmission of a power signal (e.g., a second type of signal, a third type of signal, etc.) over the isolation channel during a third portion of the communication period. For example, at block 408, the first control circuitry 202 causes transmission of the power signal over the isolation channel 240 during a third portion of the communication period. In the example of FIG. 4, at block 410, the control circuitry disposed on the first die 136 causes the isolation channel to remain idle during a fourth portion of the communication period. For example, at block 410, the first control circuitry 202 causes the isolation channel 240 to remain idle during the fourth portion of the communication period.

In the illustrated example of FIG. 4, at block 412, the control circuitry disposed on the first die 136 determines whether there is an additional communication period. For example, at block 412, the first control circuitry 202 determines whether there is an additional communication period. Based on (e.g., in response to) the first control circuitry 202 determining that there is an additional communication period (block 412: YES), the at least one of the machine-readable instructions or the operations 400 return to block 402. Based on (e.g., in response to) the first control circuitry 202 determining that there is not an additional communication period (block 412: NO), the at least one of the machine-readable instructions or the operations 400 terminate.

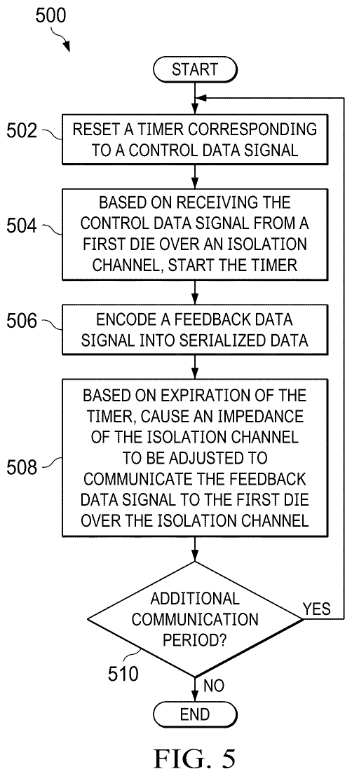

FIG. 5 is a flowchart representative of at least one of example machine-readable instructions or example operations 500 that may be at least one of executed, instantiated, or performed using an example programmable circuitry implementation of the second die 138 of the gate driver circuit 102 of FIGS. 2A and 2B. The at least one of the example machine-readable instructions or the example operations 500 of FIG. 5 begin at block 502, at which control circuitry disposed on the second die 138 resets a timer corresponding to a control data signal (e.g., a first type of signal). For example, at block 502, the second control circuitry 220 resets a timer corresponding to the control data signal.

In the illustrated example of FIG. 5, at block 504, based on receiving the control data signal from the first die 136 over an isolation channel, the control circuitry disposed on the second die 138 starts the timer. For example, at block 504, the second control circuitry 220 starts the timer based on receiving the control data signal over the isolation channel 240. At block 506, encoder circuitry disposed on the second die 138 encodes a feedback data signal into serialized data. For example, at block 506, the encoder circuitry 234 encodes the feedback data signal into serialized data. At block 508, based on expiration of the timer, the control circuitry disposed on the second die 138 causes an impedance of the isolation channel to be adjusted to communicate the feedback data signal to the first die 136 over the isolation channel. For example, based on expiration of the timer, the second control circuitry 220 causes an impedance of the isolation channel 240 to be adjusted to communicate the feedback data signal to the first die 136 over the isolation channel 240.

In the illustrated example of FIG. 5, at block 510, the control circuitry disposed on the second die 138 determines whether there is an additional communication period. For example, at block 510, the second control circuitry 220 determines whether there is an additional communication period. Based on (e.g., in response to) the second control circuitry 220 determining that there is an additional communication period (block 510: YES), the at least one of the machine-readable instructions or the operations 500 return to block 502. Based on (e.g., in response to) the second control circuitry 220 determining that there is not an additional communication period (block 510: NO), the at least one of the machine-readable instructions or the operations 500 terminate.

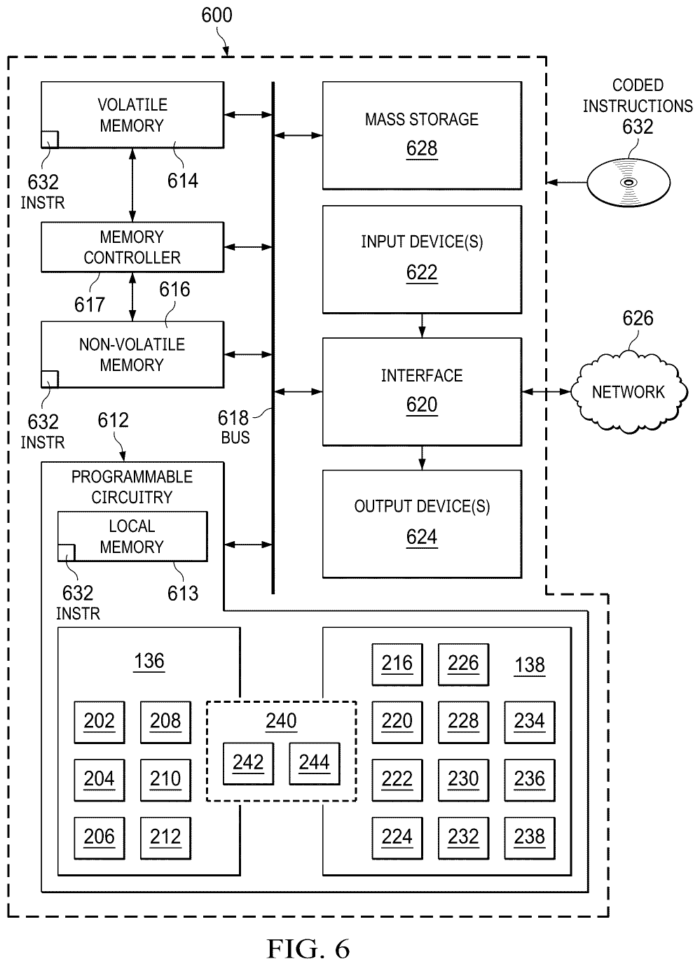

FIG. 6 is a block diagram of an example programmable circuitry platform 600 structured to one or a combination of execute or instantiate one or more of the example machine-readable instructions or the example operations of FIGS. 4 and 5 to implement the first die 136 and the second die 138 of FIGS. 2A and 2B. The programmable circuitry platform 600 can be, for example, an electronic control unit of a vehicle, control circuitry for a battery or a motor of a vehicle, or any other type of computing or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, or microcontrollers from any desired family or manufacturer. The programmable circuitry 612 may be implemented by one or more semiconductor based (e.g., silicon based) devices. In this example, the programmable circuitry 612 implements the first die 136, the second die 138, and the isolation channel 240. For example, the first die 136 includes the first control circuitry 202, the first modulator circuitry 204, the carrier signal generator circuitry 206, the excitation driver circuitry 208, the first demodulator circuitry 210, and the decoder circuitry 212. Also, for example, the second die 138 includes the second demodulator circuitry 216, the second control circuitry 220, the rectifier circuitry 222, the voltage sensing circuitry 224, the gate driver circuitry 226, the first comparator 228, the second comparator 230, the reference voltage source 232, the encoder circuitry 234, the second modulator circuitry 236, and the capacitor 238. In the example of FIG. 6, the isolation channel 240 includes the primary coil 242 and the secondary coil 244.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 616 may be implemented by one or a combination of flash memory or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter one of or a combination of data or commands into the programmable circuitry 612. The input device(s) 622 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 624 are also connected to the interface circuitry 620 of the illustrated example. The output device(s) 624 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 620 of the illustrated example, thus, includes one of or a combination of a graphics driver card, a graphics driver chip, or graphics processor circuitry such as a GPU.

The interface circuitry 620 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store one or more of firmware, software, or data. Examples of such mass storage discs or devices 628 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 632, which may be implemented by the machine-readable instructions of FIGS. 4 and 5, may be stored in one of or a combination of the mass storage device 628, in the volatile memory 614, in the non-volatile memory 616, or on at least one non-transitory computer readable storage medium such as a CD or DVD which may be removable.

While an example manner of implementing at least one of the first die 136 or the second die 138 of FIG. 1 is illustrated in FIGS. 2A and 2B, one or more of the elements, processes, or devices illustrated in FIGS. 2A and 2B may be combined, divided, re-arranged, omitted, eliminated, or implemented in any other way. Further, the first example control circuitry 202, the first example modulator circuitry 204, the example carrier signal generator circuitry 206, the example excitation driver circuitry 208, the first example demodulator circuitry 210, the example decoder circuitry 212, or, more generally, the first die 136, or the second example demodulator circuitry 216, the second example control circuitry 220, the example rectifier circuitry 222, the example voltage sensing circuitry 224, the example gate driver circuitry 226, the first example comparator 228, the second example comparator 230, the example reference voltage source 232, the example encoder circuitry 234, the second example modulator circuitry 236, the example capacitor 238, or, more generally, the second die 138, may be implemented by hardware alone or by hardware in combination with software and firmware. Thus, for example, any of the first example control circuitry 202, the first example modulator circuitry 204, the example carrier signal generator circuitry 206, the example excitation driver circuitry 208, the first example demodulator circuitry 210, the example decoder circuitry 212, or, more generally, the first die 136, or the second example demodulator circuitry 216, the second example control circuitry 220, the example rectifier circuitry 222, the example voltage sensing circuitry 224, the example gate driver circuitry 226, the first example comparator 228, the second example comparator 230, the example reference voltage source 232, the example encoder circuitry 234, the second example modulator circuitry 236, the example capacitor 238, or, more generally, the second die 138, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, at least one of the first example die 136 or the second example die 138 of FIGS. 2A and 2B may include one or more elements, processes, or devices in addition to, or instead of, those illustrated in FIGS. 2A and 2B, or may include more than one of any or all of the illustrated elements, processes and devices.

Flowchart(s) representative of example machine-readable instructions, which may be executed by programmable circuitry to at least one of implement or instantiate at least one of the first die 136 or the second die 138 of FIGS. 2A and 2B or representative of example operations which may be performed by programmable circuitry to at least one of implement or instantiate at least one of the first die 136 or the second die 138 of FIGS. 2A and 2B, are shown in FIGS. 4 and 5. The machine-readable instructions may be one or more executable programs or portion(s) of one or more executable programs for execution by programmable circuitry such as the programmable circuitry 612 shown in the example programmable circuitry platform 600 described in connection with FIG. 6 and may be one or more function(s) or portion(s) of functions to be performed by the example programmable circuitry (e.g., an FPGA). In some examples, the machine-readable instructions cause an operation, a task, etc., to be carried out or performed in an automated manner in the real-world. As used herein, “automated” means without human involvement.

The program may be embodied in instructions (e.g., at least one of software or firmware) stored on one or more of at least one non-transitory computer readable storage medium or at least one machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of at least one of the non-transitory computer readable or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with at least one of a human or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4 and 5, many other methods of implementing at least one of the first example die 136 or the second example die 138 of FIGS. 2A and 2B may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete analog circuitry, discrete digital circuitry, integrated analog circuitry, integrated digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). For example, the programmable circuitry may be one of or a combination of a CPU or an FPGA located in the same package (e.g., the same integrated circuit (IC) package or in two or more separate housings), one or more processors in a single machine, multiple processors distributed across multiple servers of a server rack, multiple processors distributed across one or more server racks, etc., or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine executable instructions. For example, the machine-readable instructions may be fragmented and stored on one or more storage devices, disks, or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to render them directly readable, interpretable, or executable by a computing device or other machine. For example, the machine-readable instructions may be stored in multiple parts, which are individually compressed, encrypted, or stored on separate computing devices, and the parts when decrypted, decompressed, or combined form a set of one or more computer-executable or machine executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 4 and 5 may be implemented using executable instructions (e.g., at least one of computer readable or machine-readable instructions) stored on one or more non-transitory computer readable or machine-readable media. As used herein, the terms non-transitory computer readable medium, non-transitory computer readable storage medium, non-transitory machine-readable medium, and non-transitory machine-readable storage medium are expressly defined to include any type of computer readable storage device or storage disk and to exclude propagating signals and to exclude transmission media. Examples of such non-transitory computer readable medium, non-transitory computer readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as at least one of voltage sources or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Uses of the phrase “ground” in the foregoing description include at least one of a chassis ground, an Earth ground, a floating ground, a virtual ground, a digital ground, a common ground, or any other form of ground connection applicable to, or suitable for, the teachings of this description.

Modifications are possible in the described embodiments, and other embodiments are possible, within the scope of the claims.

From the foregoing, it will be appreciated that example systems, apparatus, articles of manufacture, and methods have been described that transfer a power signal, a primary data signal, and a secondary data signal over an isolation barrier via a single isolation channel in an integrated circuit. For example, by time-multiplexing signals transmitted over the isolation channel examples described herein allow an isolated gate driver circuit to communicate control signals, fault diagnostic feedback, and power over the isolation barrier with a reduced footprint and monetary cost. By utilizing a single isolation channel, both data (e.g., forward data and backward data) and power are transferred over the same isolation channel, thereby eliminating the need for multiple isolation channels to transfer multiple signals. As such, the footprint and monetary cost to implement an integrated isolated gate driver circuit is reduced with respect to other isolated gate driver circuits that transfer multiple signals across an isolation barrier using multiple isolation channels. Described systems, apparatus, articles of manufacture, and methods improve the efficiency of using a computing device by facilitating an isolated gate driver circuit that is implemented in a smaller footprint. For example, by reducing the footprint size of an isolated gate driver circuit, examples described herein facilitate improved safety across a wider variety of applications. Described systems, apparatus, articles of manufacture, and methods are also directed to one or more improvement(s) in the operation of a machine such as a computer or other electronic, electromechanical, or mechanical device.

What is claimed is:

1. An apparatus comprising:
a first die having a first terminal;
a second die having a second terminal;
an isolation channel coupled between the first terminal of the first die and the second terminal of the second die; and
control circuitry disposed on the first die, the control circuitry to cause transmission of a power signal over the isolation channel and at least one of cause transmission of a control data signal over the isolation channel or detect a feedback data signal over the isolation channel.

2. The apparatus of claim 1, wherein the isolation channel includes a transformer.

3. The apparatus of claim 1, wherein the isolation channel includes a bidirectional communication channel.

4. The apparatus of claim 1, wherein the feedback data signal is indicative of at least one of a first status of a power supply voltage of the second die or a second status associated with operation of a power switch to be controlled based on the control data signal.

5. The apparatus of claim 1, wherein the control circuitry is to:
cause transmission of the control data signal over the isolation channel; and
cause transmission of the power signal over the isolation channel.

6. The apparatus of claim 1, wherein the control circuitry is to cause transmission of the control data signal over the isolation channel, and the apparatus further includes demodulator circuitry disposed on the first die, the demodulator circuitry to:
sense the feedback data signal based on a change in an impedance of the isolation channel; and
communicate the feedback data signal to the control circuitry.

7. The apparatus of claim 6, wherein the feedback data signal includes serialized data of a first feedback data signal and a second feedback data signal, and the apparatus further includes decoder circuitry disposed on the first die, the decoder circuitry to decode the serialized data into the first feedback data signal and the second feedback data signal.

8. The apparatus of claim 1, wherein the control circuitry is to:
cause transmission of the control data signal over the isolation channel during a first portion of a communication period;
detect the feedback data signal during a second portion of the communication period; and
cause transmission of the power signal over the isolation channel during a third portion of the communication period.

9. The apparatus of claim 1, wherein the control circuitry is first control circuitry, and the apparatus further includes second control circuitry disposed on the second die, the second control circuitry to:
reset a timer each communication period, the timer corresponding to the control data signal; and
based on expiration of the timer, cause an impedance of the isolation channel to be adjusted to communicate the feedback data signal over the isolation channel.

10. The apparatus of claim 9, wherein the feedback data signal includes serialized data of a first feedback data signal and a second feedback data signal, and the apparatus further includes encoder circuitry disposed on the second die, the encoder circuitry to encode the first feedback data signal and the second feedback data signal into the serialized data.

11. A system comprising:
a processor integrated circuit (IC) having an output terminal and an input terminal;
a gate driver IC having an isolation channel, a first output terminal on a first side of the isolation channel, a second output terminal on a second side of the isolation channel, and an input terminal on the first side of the isolation channel, the first output terminal of the gate driver IC coupled to the input terminal of the processor IC, the input terminal of the gate driver IC coupled to the output terminal of the processor IC; and
a power switch having a control terminal coupled to the second output terminal of the gate driver IC, the gate driver IC to:
at least one of (a) cause transmission of a control data signal for the power switch over the isolation channel or (b) provide a feedback data signal received from the second side of the isolation channel to the processor IC, the feedback data signal indicative of a status associated with the power switch; and
cause transmission of a power signal for driving the power switch over the isolation channel.

12. The system of claim 11, wherein the gate driver IC is to:
cause transmission of the control data signal for the power switch over the isolation channel; and
subsequently, cause transmission of the power signal for driving the power switch over the isolation channel.

13. The system of claim 11, wherein the gate driver IC is to:
sense the feedback data signal based on a change in an impedance of the isolation channel; and
provide the feedback data signal to the processor IC.

14. The system of claim 13, wherein the feedback data signal includes serialized data of a first feedback data signal and a second feedback data signal, and the gate driver IC is to:
decode the serialized data into the first feedback data signal and the second feedback data signal; and
provide the first feedback data signal to the processor IC and provide the second feedback data signal to the processor IC.

15. The system of claim 11, wherein the gate driver IC is to:
cause transmission of the control data signal over the isolation channel during a first portion of a communication period;
detect the feedback data signal during a second portion of the communication period; and
cause transmission of the power signal over the isolation channel during a third portion of the communication period.

16. The system of claim 11, wherein the gate driver IC is to:
reset a timer each communication period, the timer corresponding to the control data signal; and
based on expiration of the timer, adjust an impedance of the isolation channel to communicate the feedback data signal over the isolation channel.

17. An apparatus comprising:
a first die having a first terminal;
a second die having a second terminal;
an isolation channel coupled between the first terminal of the first die and the second terminal of the second die; and
control circuitry disposed on the first die, the control circuitry to:
cause transmission of a control data signal over the isolation channel during a first portion of a communication period;
detect a feedback data signal during a second portion of the communication period; and
cause transmission of a power signal over the isolation channel during a third portion of the communication period.

18. The apparatus of claim 17, wherein the control circuitry is first control circuitry, and the apparatus further includes second control circuitry disposed on the second die, the second control circuitry to:
reset a timer each communication period, the timer corresponding to the control data signal; and
based on expiration of the timer, cause an impedance of the isolation channel to be adjusted to communicate the feedback data signal over the isolation channel.

19. The apparatus of claim 17, wherein the feedback data signal includes serialized data of a first feedback data signal and a second feedback data signal, and the apparatus further includes encoder circuitry disposed on the second die, the encoder circuitry to encode the first feedback data signal and the second feedback data signal into the serialized data.

20. The apparatus of claim 17, wherein the feedback data signal is indicative of at least one of a first status of a power supply voltage of the second die or a second status associated with operation of a power switch to be controlled based on the control data signal.
